(19) United States
(12) Patent Application Publication
(10) Pub. No.: US 2022/0085386 A1
(43) Pub. Date: Mar. 17, 2022

(54) MEMBRANE ELECTRODE ASSEMBLY COMPRISING CARBON LAYER ON CATALYST LAYER AND FUEL CELL COMPRISING THE SAME

(71) Applicant: KOREA INSTITUTE OF SCIENCE AND TECHNOLOGY, Seoul (KR)

(72) Inventors: Sung Jong YOO, Seoul (KR); Sang Moon KIM, Gwangmyeong-si (KR); Changwook SEOL, Incheon (KR); Segeun JANG, Daejeon (KR)

(73) Assignee: KOREA INSTITUTE OF SCIENCE AND TECHNOLOGY, Seoul (KR)

(21) Appl. No.: 17/470,120

(22) Filed: Sep. 9, 2021

(30) Foreign Application Priority Data
Sep. 11, 2020 (KR) 10-2020-0116753

(51) Int. Cl. H01M 4/88; H01M 8/1004; H01M 4/86

(52) U.S. Cl. CPC H01M 4/8825; H01M 2008/1095; H01M 4/8668; H01M 8/1004

(57) ABSTRACT

The present disclosure relates to a membrane electrode assembly including: a polymer electrolyte membrane; an anode catalyst layer formed on one side of the polymer electrolyte membrane; a cathode catalyst layer formed on the other side of the polymer electrolyte membrane; and a porous carbon layer formed on the cathode catalyst layer on the side opposite to the side contacting with the polymer electrolyte membrane and comprising a polymer binder and a carbon particle, and a fuel cell including the same. The present disclosure can prevent water evaporation from an electrolyte under low-humidity environment while minimizing decrease in performance under high-humidity operating environment and can improve fuel cell performance by facilitating the back diffusion of water generated at the cathode.

### CROSS-REFERENCE TO RELATED APPLICATIONS

This application claims priority under 35 U.S.C. § 119 to Korean Patent Application No. 10-2020-0116753 filed on Sep. 11, 2020 in the Korean Intellectual Property Office, the disclosure of which is incorporated herein by reference in its entirety.

### TECHNICAL FIELD

The present disclosure relates to a membrane electrode assembly and a fuel cell including the same. More particularly, it relates to a membrane electrode assembly capable of improving the performance of a fuel cell by including a carbon layer on a catalyst layer of the membrane electrode assembly, and a fuel cell including the same.

### BACKGROUND

A polymer electrolyte membrane fuel cell is a device which converts chemical energy to electrical energy. It enables utilization of energy with higher efficiency than the existing internal combustion engines and a uses a clean energy source not emitting environmental pollutants such as carbon dioxide, nitrogen oxides, sulfur oxides, etc. In a fuel cell, a gaseous fuel such as hydrogen, etc. is supplied to an anode and an air fuel such as oxygen, etc. is supplied to a cathode. As hydrogen is oxidized at the anode, electrons are emitted through an external circuit connected to the fuel cell. Ions produced while oxygen is reduced using the electrons emitted from the cathode are transported through a polymer electrolyte membrane located between the anode and the cathode. Electrical energy is generated as this process is repeated.

The polymer electrolyte membrane fuel cell can be used as an energy source for mobile applications, vehicles, power generation, etc. due to the advantages of low operation temperature, high performance, fast operation and various outputs. As described above, the polymer electrolyte membrane fuel cell is composed of an anode, a cathode and a polymer membrane serving as an electrolyte. As the polymer membrane, a membrane with sulfonate groups (—SO₃H) introduced for conduction of hydrogen ions is usually used. A typical example is DuPont's Nafion.

The existing polymer electrolyte membrane can exhibit high fuel cell performance because hydrogen ion conductivity is high under high-humidity environments. However, under low-humidity operating environments, hydrogen ion conductivity is decreased due to drying of the membrane and, as a result, the performance of a fuel cell is decreased greatly. To solve this problem, the performance under low-humidity environment has been improved by inhibiting evaporation of water by inserting an organic or inorganic particle or a polymer material having hygroscopic property inside or outside a catalyst layer.

However, the water produced in the catalyst layer under high-humidity operating environment decreases the surface area of reaction by covering the surface of the catalyst, resulting in decreased fuel cell performance (flooding phenomenon). At present, a technology capable of improving the performance of a fuel cell under various humidity conditions is not available yet.

Therefore, there is needed for the development of a technology about a membrane electrode assembly of a fuel cell which can achieve improvement in performance not only in low-humidity operating environment but also in high-humidity operating environment.

### REFERENCES OF THE RELATED ART

### Patent Documents

(Patent document 1) Korean Patent Publication No. 10-2017-0061577.
(Patent document 2) Korean Patent Registration Publication No. 10-0645832.

### SUMMARY

The present disclosure is directed to, by introducing a porous carbon layer on a cathode catalyst layer, providing a membrane electrode assembly capable of preventing water evaporation from an electrolyte under low-humidity environment while minimizing decrease in performance under high-humidity operating environment, improving fuel cell performance by facilitating the back diffusion of water generated at the cathode, and improving performance under various humidity environments by controlling the concentration of a polymer used as a polymer binder included in the porous carbon layer and the thickness of the porous carbon layer, and a polymer electrolyte membrane including the same.

According to an aspect of the present disclosure, there is provided a membrane electrode assembly including:

a polymer electrolyte membrane;

an anode catalyst layer formed on one side of the polymer electrolyte membrane;

a cathode catalyst layer formed on the other side of the polymer electrolyte membrane; and

a porous carbon layer,

wherein the porous carbon layer is formed on the cathode catalyst layer on the side opposite to the side contacting with the polymer electrolyte membrane and includes a polymer binder and a carbon particle.

The polymer binder may include any one selected from polytetrafluoroethylene, a perfluorosulfonate polymer, polyvinyl alcohol, polyvinyl butyral, polyvinylidene fluoride, a hydrocarbon-based polymer, polyimide, polyethersulfone, polyphenylene sulfide, polyphenylene oxide, polyphosphazene, polyethylene naphthalate, polyester, polyetherketone and polysulfone.

The carbon particle may be any one selected from carbon black, graphite, carbon nanotube, graphene and fullerene.

The content of the polymer binder may be 5-50 wt % based on the total weight of the porous carbon layer.

The polymer electrolyte membrane may include one selected from a perfluorosulfonate polymer, polyvinylidene fluoride, a hydrocarbon-based polymer, polyimide, polyethersulfone, polyphenylene sulfide, polyphenylene oxide, polyphosphazene, polyethylene naphthalate, polyester, polyetherketone and polysulfone.

The anode catalyst layer or the cathode catalyst layer may include a carbon support and a metal catalyst supported on the carbon support.

The metal catalyst may include one or more selected from platinum (Pt), copper (Cu), silver (Ag), gold (Au), cobalt (Co), nickel (Ni), ruthenium (Ru), rhodium (Rh), palladium (Pd), osmium (Os), iridium (Ir), tin (Sn), titanium (Ti) and chromium (Cr).

The porous carbon layer may have a thickness of 3-50 μm.

According to another aspect of the present disclosure, there is provided a method for preparing a membrane electrode assembly, which includes:

(a) a step of preparing a carbon particle-containing ink containing a carbon particle and a polymer binder;

(b) a step of forming an anode catalyst layer and a cathode catalyst layer by coating a catalyst ink containing a metal catalyst on both sides of a polymer electrolyte membrane; and

(c) a step of forming a porous carbon layer by coating the carbon particle-containing ink on the surface of the cathode catalyst layer.

In the step (a), the carbon particle-containing ink may be prepared such that the content of the polymer binder is 5-50 wt % based on the total weights of the carbon particle and the polymer binder.

The coating of the catalyst ink or the carbon particle-containing ink may be performed by any method selected from spray coating, spin coating, bar coating and dip coating.

In the step (c), the porous carbon layer may be coated to a thickness of 3-50 μm.

According to another aspect of the present disclosure, there is provided a fuel cell including the membrane electrode assembly.

According to another aspect of the present disclosure, there is provided a method for preparing a fuel cell, which includes the method for preparing a membrane electrode assembly described above.

The membrane electrode assembly of the present disclosure and a fuel cell including the same can, by introducing a porous carbon layer on a cathode catalyst layer, prevent water evaporation from an electrolyte under low-humidity environment while minimizing decrease in performance under high-humidity operating environment, improve fuel cell performance by facilitating the back diffusion of water generated at the cathode, and improve performance under various humidity environments by controlling the concentration of a polymer used as a polymer binder included in the porous carbon layer and the thickness of the porous carbon layer.

### BRIEF DESCRIPTION OF DRAWINGS

FIG. 1 schematically shows a membrane electrode assembly of the present disclosure.

FIG. 2 shows the SEM images of membrane electrode assemblies of Examples 1-3 and a membrane electrode assembly of Comparative Example 1 and the EDS images of carbon or platinum.

FIGS. 3A and 3B show results of evaluating the performance of a fuel cell depending on the Nafion ionomer concentration of a porous carbon layer in Test Example 1.

FIGS. 4A and 4B show results of evaluating the performance of a fuel cell depending on the thickness of a porous carbon layer in Test Example 2.

FIGS. 5A and 5B show results of electrochemical impedance spectroscopy (EIS) analysis in Test Example 3.

### DETAILED DESCRIPTION OF EMBODIMENTS

Hereinafter, various aspects and exemplary embodiments of the present disclosure will be described more specifically. Hereinafter, the exemplary embodiments of the present disclosure will be described in detail referring to the attached drawings so that those having ordinary knowledge in the art to which the present disclosure belongs can easily carry out the present disclosure.

However, the following description is not intended to limit the present disclosure to specific exemplary embodiments. In the description of the present disclosure, detailed description of related known techniques will be omitted when it may make the gist of the present disclosure unclear.

The terms used in the present disclosure are used only to describe the specific exemplary embodiments and are not intended to limit the present disclosure. Unless stated explicitly otherwise, the singular expression includes a plural expression. In the present disclosure, the terms “include”, “have”, etc. are used to designate the presence of features, numbers, steps, operations, elements, parts or combinations thereof described in the present disclosure, and should be understood as not excluding the presence or possibility of addition of one or more different features, numbers, steps, operations, elements, parts or combinations thereof.

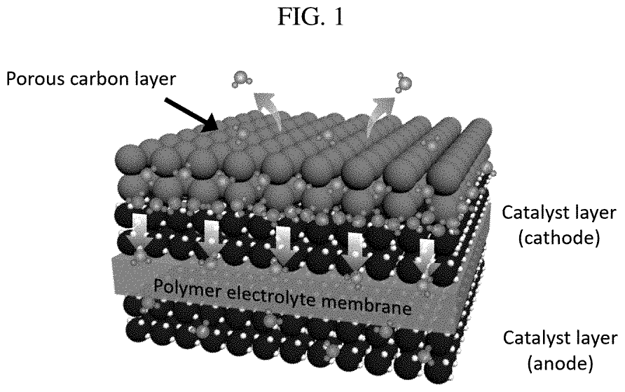

FIG. 1 schematically shows a membrane electrode assembly of the present disclosure.

Hereinafter, the membrane electrode assembly of the present disclosure will be described referring to FIG. 1.

The membrane electrode assembly of the present disclosure includes a polymer electrolyte membrane, an anode catalyst layer, a cathode catalyst layer and a porous carbon layer.

Specifically, the membrane electrode assembly of the present disclosure includes: a polymer electrolyte membrane; an anode catalyst layer formed on one side of the polymer electrolyte membrane; a cathode catalyst layer formed on the other side of the polymer electrolyte membrane; and a porous carbon layer, wherein the porous carbon layer is formed on the cathode catalyst layer on the side opposite to the side contacting with the polymer electrolyte membrane and includes a polymer binder and a carbon particle.

Specifically, the polymer binder may be polytetrafluoroethylene, a perfluorosulfonate polymer, polyvinyl alcohol, polyvinyl butyral, polyvinylidene fluoride, a hydrocarbon-based polymer, polyimide, polyethersulfone, polyphenylene sulfide, polyphenylene oxide, polyphosphazene, polyethylene naphthalate, polyester, polyetherketone, polysulfone, etc. More specifically, polytetrafluoroethylene, perfluorosulfonate polymer, polyvinyl alcohol or polyvinyl butyral may be used. Further more specifically, Nafion may be used.

The carbon particle may be carbon black, graphite, carbon nanotube, graphene, fullerene, etc. More specifically, it may be carbon black.

The content of the polymer binder based on the total weight of the porous carbon layer may be specifically 5-40 wt %, more specifically 10-38 wt %, further more specifically 25-35 wt %. If the content of the polymer binder is below 5 wt %, the durability of the porous carbon layer may decrease. And, if the content exceeds 40 wt %, the performance of a fuel cell may be degraded due to flooding phenomenon under high-humidity operating environment.

As the polymer electrolyte membrane, a perfluorosulfonate polymer, polyvinylidene fluoride, a hydrocarbon-based polymer, polyimide, polyethersulfone, polyphenylene sulfide, polyphenylene oxide, polyphosphazene, polyethylene naphthalate, polyester, polyetherketone, polysulfone, etc. may be used specifically. More specifically, a perfluorosulfonate polymer may be used. Further more specifically, Nafion may be used.

The anode catalyst layer or the cathode catalyst layer may include a carbon support and a metal catalyst supported on the carbon support.

The metal catalyst may be any one selected from platinum (Pt), copper (Cu), silver (Ag), gold (Au), cobalt (Co), nickel (Ni), ruthenium (Ru), rhodium (Rh), palladium (Pd), osmium (Os), iridium (Ir), tin (Sn), titanium (Ti) and chromium (Cr) or an alloy thereof, although the scope of the present disclosure is not limited thereto.

The metal catalyst particle may have an average particle diameter of 2-10 nm, more specifically 3-7 nm.

For effective activation of electrode reaction and prevention of excessively increased electrical resistance, the anode catalyst layer or the cathode catalyst layer may be formed to have a thickness of specifically 1-50 μm, more specifically 5-40 μm, further more specifically 10-25 μm. If the thickness of the catalyst layer is smaller than 1 μm, the activation of electrode reaction may be insufficient. And, if it exceeds 50 μm, fuel cell output may be decreased due to increased electrical resistance and material transport resistance.

The porous carbon layer may have a thickness of specifically 3-50 μm, more specifically 5-40 μm, further more specifically 5-30 μm, most specifically 10-20 μm. If the thickness is smaller than 3 μm, the prevention of water evaporation may be insufficient. And, if it exceeds 50 μm, fuel cell output may be decreased due to increased material transport resistance or due to the flooding phenomenon where water generated in the catalyst layer covers the catalyst surface, thereby decreasing reaction surface area.

Hereinafter, the method for preparing a membrane electrode assembly for a fuel cell of the present disclosure is described.

First, a carbon particle-containing ink containing a carbon particle and a polymer binder is prepared (step a).

The content of the polymer binder based on the total weight of the porous carbon layer may be specifically 5-40 wt %, more specifically 10-40 wt %, further more specifically 25-35 wt %. If the content of the polymer binder is below 5 wt %, the durability of the porous carbon layer may decrease. And, if it exceeds 40 wt %, the performance of a fuel cell may be decreased due to flooding phenomenon under high-humidity operating environment.

The polymer binder may be specifically polytetrafluoroethylene, a perfluorosulfonate polymer, polyvinyl alcohol, polyvinyl butyral, polyvinylidene fluoride, a hydrocarbon-based polymer, polyimide, polyethersulfone, polyphenylene sulfide, polyphenylene oxide, polyphosphazene, polyethylene naphthalate, polyester, polyetherketone, polysulfone, etc., more specifically polytetrafluoroethylene, a perfluorosulfonate polymer, polyvinyl alcohol or polyvinyl butyral, further more specifically Nafion.

The carbon particle may be carbon black, graphite, carbon nanotube, graphene, fullerene, etc., specifically carbon black.

Next, an anode catalyst layer and a cathode catalyst layer are formed by coating a catalyst ink containing a metal catalyst on both sides of a polymer electrolyte membrane (step b).

The metal catalyst may be any one selected from platinum (Pt), copper (Cu), silver (Ag), gold (Au), cobalt (Co), nickel (Ni), ruthenium (Ru), rhodium (Rh), palladium (Pd), osmium (Os), iridium (Ir), tin (Sn), titanium (Ti) and chromium (Cr) or an alloy thereof, although the scope of the present disclosure is not limited thereto.

The metal catalyst particle may have an average particle diameter of 2-10 nm, more specifically 3-7 nm.

The coating of the catalyst ink may be performed by spray coating, spin coating, bar coating, dip coating, etc., specifically by spray coating.

For effective activation of electrode reaction and prevention of excessively increased electrical resistance, the anode catalyst layer or the cathode catalyst layer may be coated to a thickness of specifically 1-100 μm, more specifically 5-80 μm, further more specifically 10-50 μm. If the thickness of the catalyst layer is smaller than 1 μm, the activation of electrode reaction may be insufficient. And, if it exceeds 100 μm, fuel cell output may be decreased due to increased electrical resistance.

Thereafter, a porous carbon layer is formed by coating the carbon particle-containing ink on the surface of the cathode catalyst layer (step c).

The coating of the carbon particle-containing ink may be performed by spray coating, spin coating, bar coating, dip coating, etc., specifically by spray coating.

The porous carbon layer may have a thickness of specifically 3-50 μm, more specifically 5-40 μm, further more specifically 5-30 μm, most specifically 10-20 μm. If the thickness is smaller than 3 μm, the prevention of water evaporation may be insufficient. And, if it exceeds 50 μm, fuel cell output may be decreased due to increased material transport resistance or due to the flooding phenomenon where water generated in the catalyst layer covers the catalyst surface, thereby decreasing reaction surface area.

Although it was not described explicitly in the following examples, membrane electrode assemblies were prepared while changing the conditions of the carbon particle, the polymer binder and the content of the polymer binder of the carbon particle-containing ink in the step (a), the metal catalyst, the thickness of the anode catalyst layer and the cathode catalyst layer and the coating method of the metal catalyst ink in the step (b) and the content of the polymer binder, the thickness of the porous carbon layer and the coating method of the carbon particle-containing ink in the step (c).

As a result of investigating the performance of the membrane electrode assemblies and polymer electrolyte membrane fuel cells using the same, it was confirmed that it is very important that (i) the content of the polymer binder in the step (a) is 25-35 wt % based on the total contents of the porous carbon particle and the polymer binder and (ii) the thickness of the porous carbon layer is 10-20 μm. In this case, water evaporation could be prevented under low-humidity condition, back diffusion of water generated at the cathode could be facilitated and flooding did not occur even under high-humidity condition.

It was confirmed that, if any of the two conditions is not satisfied, ohmic resistance may increase and/or material transport problem may occur. Also, it was confirmed that ohmic resistance or material transport resistance may be increased as compared to when there is no porous carbon layer.

In addition, it was confirmed that, only when all of the following conditions are satisfied, water evaporation from the electrolyte under low-humidity environment is prevented while the decrease in performance under high-humidity operating environment is minimized and superior fuel cell performance is achieved as the facilitation of back diffusion of water produced at the cathode is maximized. In addition, there was no problem of interfacial contact between the porous carbon layer and the catalyst layer.

The conditions are as follows: in the step (a), \textcircled{1} the carbon particle of the carbon particle-containing ink is carbon black, \textcircled{2} the polymer binder is Nafion and \textcircled{3} the content of the polymer binder is 25-35 wt %; in the step (b), \textcircled{4} the metal catalyst is a platinum catalyst and \textcircled{5} the thickness of the anode catalyst layer and the cathode catalyst layer is 10-25 μm; and in the step (c), \textcircled{6} the thickness of the porous carbon layer is 10-20 μm.

The present disclosure also provides a fuel cell including the membrane electrode assembly.

In addition, the present disclosure provides a method for preparing a fuel cell, which includes the method for preparing a membrane electrode assembly.

Hereinafter, the present disclosure is described through examples. However, the scope of the present disclosure is not limited by the examples.

### EXAMPLES

### Preparation Example 1: Carbon Particle-Containing Ink

In order to insert a porous carbon layer outside a cathode catalyst layer, a carbon particle-containing ink was prepared by mixing Vulcan XC-72 carbon particles with a 5 wt % Nafion ionomer solution. The mixture solution was sonicated so that the particles were dispersed enough without aggregation. The content of the Nafion ionomer was set to 10 wt % of the total weight of the carbon particle and the Nafion polymer.

### Preparation Example 2: Carbon Particle-Containing Ink

A carbon particle-containing ink was prepared under the same condition as in Preparation Example 1 except that the content of the Nafion ionomer was set to 20 wt %, instead of 10 wt %, of the carbon particle and the Nafion polymer.

### Preparation Example 3: Carbon Particle-Containing Ink

A carbon particle-containing ink was prepared under the same condition as in Preparation Example 1 except that the content of the Nafion ionomer was set to 30 wt %, instead of 10 wt %, of the carbon particle and the Nafion polymer.

### Preparation Example 4: Carbon Particle-Containing Ink

A carbon particle-containing ink was prepared under the same condition as in Preparation Example 1 except that the content of the Nafion ionomer was set to 40 wt %, instead of 10 wt %, of the carbon particle and the Nafion polymer.

### Example 1: Membrane Electrode Assembly (MEA) with Porous Carbon layer inserted outside catalyst layer of fuel cell

First, Pt/C with a metal loading content of 40 wt % and a 5 wt % Nafion ionomer solution was prepared. In the mixture, the content of the Nafion ionomer was 23 wt % based on the total dry weight of Nafion and Pt/C. Then, a Pt/C catalyst ink was prepared by adding deionized water and isopropyl alcohol and controlling viscosity adequately.

Then, 0.2 mg Pt/cm² catalyst layers were formed on a cathode and an anode by spray-coating the Pt/C catalyst ink directly on a Nafion polymer electrolyte membrane (Nafion 211 membrane).

A porous carbon layer was formed outside the cathode catalyst layer of the membrane electrode assembly by spray-coating the carbon particle-containing ink prepared in Preparation Example 3. A membrane electrode assembly (MEA) was prepared by spray-coating the porous carbon layer to a thickness of 5 μm.

### Example 2: Membrane Electrode Assembly (MEA) with Porous Carbon Layer Inserted Outside Catalyst Layer of Fuel Cell

A membrane electrode assembly was prepared in the same manner as in Example 1 except that the porous carbon layer was formed with a thickness of 15 μm instead of 5 μm.

### Example 3: Membrane Electrode Assembly (MEA) with Porous Carbon Layer Inserted Outside Catalyst Layer of Fuel Cell

A membrane electrode assembly was prepared in the same manner as in Example 1 except that the porous carbon layer was formed with a thickness of 25 μm instead of 5 μm.

### Comparative Example 1: Membrane Electrode Assembly (MEA)

A membrane electrode assembly was prepared in the same manner as in Example 1 except that the porous carbon layer was not formed.

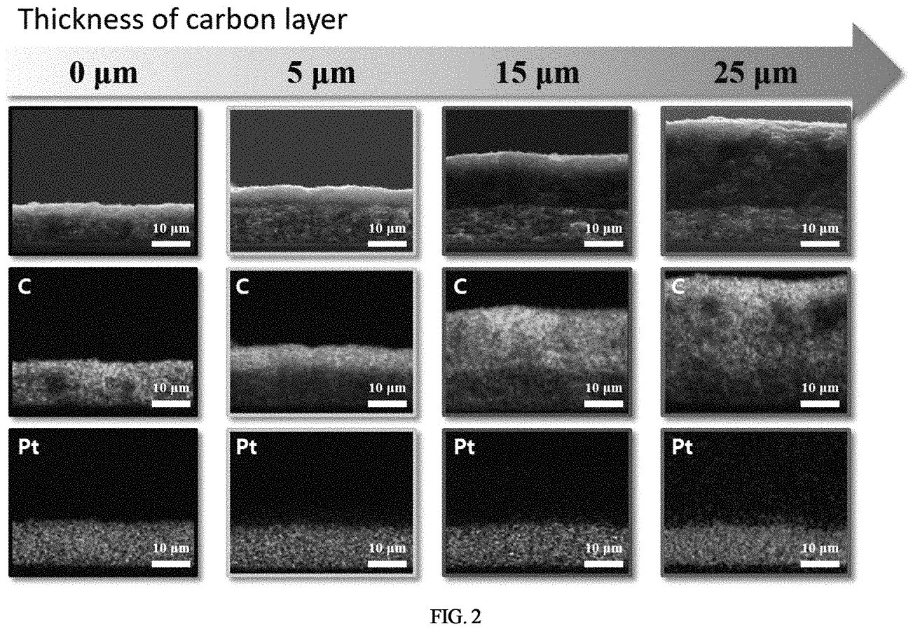

FIG. 2 (a) shows the SEM images of the membrane electrode assemblies of Examples 1-3 having porous carbon layers of different thicknesses and the membrane electrode assembly of Comparative Example 1 with no porous carbon layer. FIG. 2 (b) shows the EDS (elemental mapping) images of carbon (C) and FIG. 2 (c) shows the EDS images of platinum (Pt).

### Device Example 1: Preparation of Fuel Cell

A fuel cell was prepared by forming sequentially, on the membrane electrode assembly with a 5-μm-thick porous carbon layer inserted prepared in Example 1, a gas diffusion layer, a bipolar plate and an end plate.

### Device Example 2: Preparation of Fuel Cell

A fuel cell was prepared under the same condition as in Device Example 1 except that a porous carbon layer with a thickness of 15 μm instead of 5 μm was formed in the membrane electrode assembly.

### Device Example 3: Preparation of Fuel Cell

A fuel cell was prepared under the same condition as in Device Example 1 except that a porous carbon layer with a thickness of 25 μm instead of 5 μm was formed in the membrane electrode assembly.

### Comparative Device Example 1: Preparation of Fuel Cell

A fuel cell was prepared under the same condition as in Device Example 1 except that a commercially available membrane electrode assembly without a porous carbon layer was used.

### TEST EXAMPLES

### Test Example 1: Evaluation of Fuel Cell Performance Depending on Nafion Ionomer Content

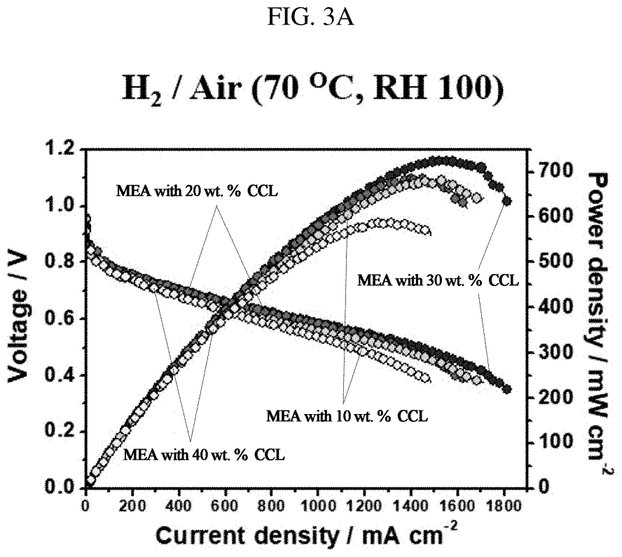

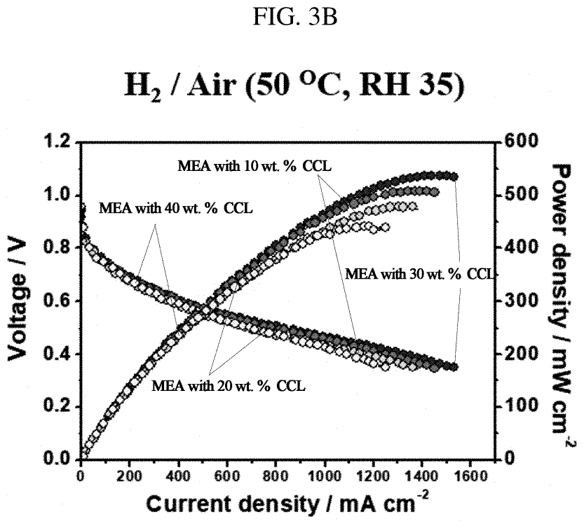

The performance of the fuel cells including the 15-μm-thick membrane electrode assembly, prepared using the carbon particle-containing inks of different Nafion ionomer concentrations of Preparation Example 1-4, was evaluated under the operating condition of 70° C. and relative humidity (RH) 100% (a) or 50° C. and relative humidity (RH) 35% (b), with a fuel cell active area of 5 cm². The result is shown in FIGS. 3A and 3B.

It can be seen that, among the samples with Nafion ionomer concentrations of 10, 20, 30 and 40 wt %, the 30 wt % sample showed the best performance under the two operating conditions.

Through this, it can be seen that the Nafion ionomer concentration which is favorable in terms of material transport without the problem of interfacial contact between the catalyst layer and the gas diffusion layer is 30 wt %.

### Test Example 2: Evaluation of Fuel Cell Performance Depending on Thickness of Porous Carbon Layer

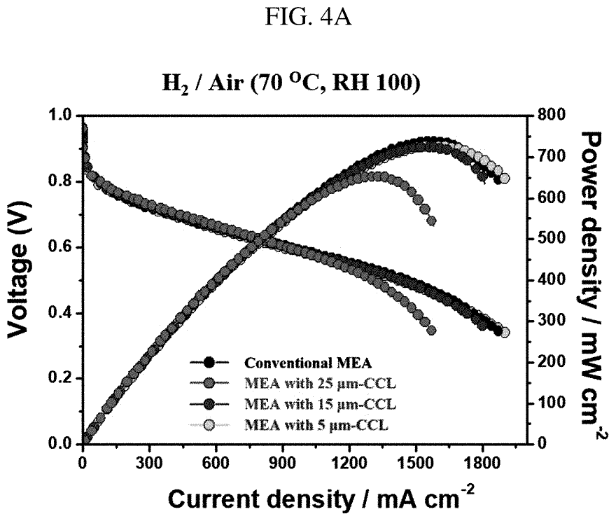

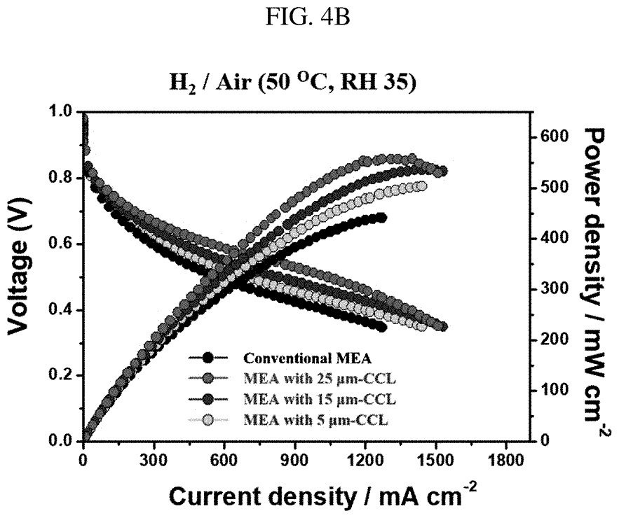

The Nafion ionomer concentration was fixed to 30 wt % based on the result of Test Example 1 and the performance of the fuel cells of Device Examples 1-3 having porous carbon layers with a thickness 5 μm, 15 μm or 25 μm was evaluated under the operating condition of 70° C. and relative humidity (RH) 100% (a) or 50° C. and relative humidity (RH) 35% (b). The results are shown in FIGS. 4A and 4B.

As seen from FIG. 4A, the fuel cells of Device Examples 1 and 2 having porous carbon layers with thicknesses of 5 μm and 15 μm showed almost similar performance to Comparative Device Example 1 with no additional porous carbon layer under the high-humidity operating condition of 70° C. and relative humidity (RH) 100%. This means that the carbon material used as a catalyst support could be adequately contacted interfacially with the Nafion ionomer used as a binder without additional increase in resistance or material transport problem. However, for the fuel cell of Device Example 3 having a porous carbon layer with a thickness of 25 μm, performance was decreased as compared to Device Example 1 or 2 due to increased material transport resistance owing to the larger carbon layer thickness.

As seen from FIG. 4B, under the low-humidity operating condition of 50° C. and relative humidity (RH) 35%, all the fuel cells of Device Examples 1-3 having porous carbon layers showed improved performance as compared to Comparative Device Example 1. Unlike the high-humidity environment, the decrease in cell performance was not observed. The fuel cell of Device Example 2 having a porous carbon layer with a thickness of 15 μm showed increase in maximum output density by 22.1% and increase in current density at 0.6V by 44.8%.

### Test Example 3: Electrochemical Impedance Spectroscopy (EIS) Analysis

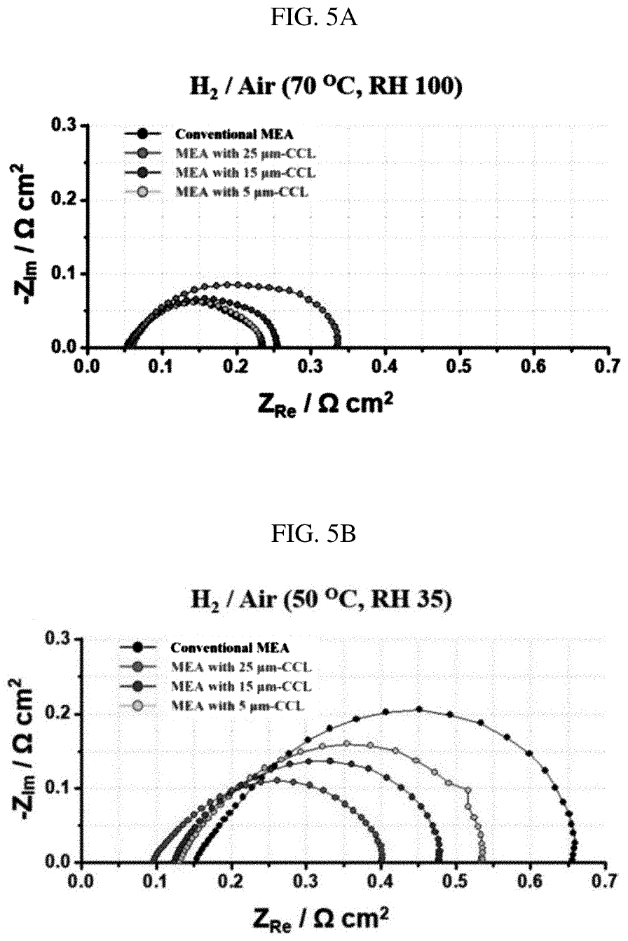

In order to investigate the effect of the membrane electrode assembly with a porous carbon layer inserted outside a catalyst layer of a fuel cell, the membrane electrode assemblies of Device Examples 1-3 having porous carbon layers with different thicknesses and Comparative Device Example 1 with no porous carbon layer were subjected to electrochemical impedance spectroscopy analysis under high-humidity environment (70° C., RH 100, (a)) and low-humidity environment (50° C., RH 35, (b)) at 0.6 V. The results are shown in FIGS. 5A and 5B. The electrochemical impedance spectroscopy data under the high-humidity condition are summarized in Table 1, and the data under the low-humidity condition are summarized in Table 2.

TABLE 1

| | Current | | | |
|---|---|---|---|---|
| | density | Max. power | R_{membrane} | R_{cathode} |
| 70° C., | at 0.6 V | density | (at 0.6 V) | (at 0.6 V) |
| RH 100% | [mA cm⁻²] | [mW cm⁻²] | [Ω cm²] | [Ω cm²] |
| Conventional | 931 | 737 | 0.0575 | 0.1775 |
| MEA | (−) | (−) | (−) | (−) |
| MEA with | 900 | 727 | 0.0590 | 0.1750 |
| 5 μm-CCL | (−3.33%) | (−1.36%) | (+2.61%) | (−1.41%) |
| MEA with | 921 | 727 | 0.0530 | 0.2005 |
| 15 μm-CCL | (−1.01%) | (−1.36%) | (−7.83%) | (+12.9%) |
| MEA with | 921 | 653 | 0.0550 | 0.2328 |
| 25 μm-CCL | (−1.01%) | (−11.4%) | (−4.35%) | (+31.1%) |

As seen from FIG. 5A and Table 1, the ohmic resistance under the high-humidity environment was 0.0590 Ω cm², 0.0530 Ω cm² and 0.0550 Ω cm² for Device Examples 1-3, respectively, and 0.0575 Ω cm² for Comparative Device Example 1. However, Device Example 3 having a porous carbon layer with a thickness of 25 μm showed a kinetic resistance of electrochemical reaction at the cathode of 0.2328 Ω cm², which was increased by 31.1% as compared to 0.1775 Ω cm² of Comparative Device Example 1. This result shows that, although the limitation of the thickness of the porous carbon layer can reduce the decrease in material transport at the cathode of the fuel cell, it can result in the retention of water on the cathode.

TABLE 2

| | Current | | | |
|---|---|---|---|---|
| | density | Max. power | R_{membrane} | R_{cathode} |
| 50° C., | at 0.6 V | density | (at 0.6 V) | (at 0.6 V) |
| RH 35% | [mA cm⁻²] | [mW cm⁻²] | [Ω cm²] | [Ω cm²] |
| Conventional | 290 | 443 | 0.1530 | 0.5025 |
| MEA | (−) | (−) | (−) | (−) |
| MEA with | 350 | 505 | 0.1300 | 0.4053 |
| 5 μm-CCL | (+20.7%) | (+14.0%) | (−15.0%) | (−19.3%) |
| MEA with | 420 | 541 | 0.1225 | 0.3550 |
| 15 μm-CCL | (+44.8%) | (+22.1%) | (−19.9%) | (−29.3%) |
| MEA with | 541 | 562 | 0.0940 | 0.3064 |
| 25 μm-CCL | (+86.5%) | (+26. [symbol] %) | (−38.6\|%) | (−39.0%) |

[symbol]

indicates data missing or illegible when filed

In addition, as seen from FIG. 5B and Table 2, the fuel cells of Device Examples 1-3 having porous carbon layers with different thicknesses showed decreased ohmic resistance of 0.1300 Ω cm², 0.1225 Ω cm² and 0.0940 Ω cm², respectively, under the low-humidity condition, which was much lower than that of the fuel cell of Comparative Device Example 1 (0.1530 Ω cm²).

In addition, Device Examples 1-3 showed kinetic resistance at the cathode decreased by up to 39.0% as compared to the fuel cell of Comparative Device Example 1.

Based on these experimental results, it can be seen that the fuel cell of Device Example 2 having a porous carbon layer with a thickness of 15 μm can improve the fuel cell performance under the low-humidity condition with minimized side effects. The fuel cell of Device Example 2 showed remarkably improved fuel cell performance, with ohmic resistance decreased by 19.9% and material transport resistance decreased by 29.4%, as compared to the existing fuel cell of Comparative Device Example 1.

Accordingly, it was confirmed that a fuel cell exhibiting superior performance under various humidity conditions including dry and humidified conditions by inserting a porous carbon layer including a polymer binder outside a catalyst layer of a membrane electrode assembly can be prepared. That is to say, it was confirmed that superior performance can be achieved without flooding problem even under high-humidity condition by preventing water evaporation from an electrolyte under low-humidity environment while minimizing decrease in performance during fuel cell operation under high-humidity operating environment and facilitating the back diffusion of water generated at the cathode.

While the exemplary embodiments of the present disclosure have been described in detail, those having ordinary knowledge in the art will be able to modify and change the present disclosure variously without departing from the technical spirit of the present disclosure defined in the claims, which are included in the scope of the present disclosure.

What is claimed is:

1. A method for preparing a membrane electrode assembly, comprising:
(a) a step of preparing a carbon particle-containing ink comprising a carbon particle and a polymer binder;
(b) a step of forming an anode catalyst layer and a cathode catalyst layer by coating a catalyst ink comprising a metal catalyst on both sides of a polymer electrolyte membrane; and
(c) a step of forming a porous carbon layer by coating the carbon particle-containing ink on the surface of the cathode catalyst layer.

2. The method for preparing a membrane electrode assembly according to claim 1, wherein the content of the polymer binder is 25-35 wt % based on the total contents of the carbon particle and the polymer binder, and the porous carbon layer has a thickness of 10-20 μm.

3. The method for preparing a membrane electrode assembly according to claim 1, wherein the carbon particle is a carbon black particle, the polymer binder is Nafion, and the catalyst is a platinum catalyst.
